(19) United States
(12) Patent Application Publication
(10) Pub. No.: US 2014/0215848 A1
(43) Pub. Date: Aug. 7, 2014

(54) DEVICE FOR TREATING A MATERIAL, IN PARTICULAR FOR DRYING A PREFERABLY STRIP-SHAPED MATERIAL

(71) Applicant: Markus Böhn, Hainburg (DE)

(72) Inventor: Markus Böhn, Hainburg (DE)

(21) Appl. No.: 14/346,102

(22) PCT Filed: Sep. 12, 2012
(86) PCT No.: PCT/EP2012/067831

§ 371 Date: Mar. 20, 2014

(30) Foreign Application Priority Data
Sep. 21, 2011 (DE) 10 2011 113 835.1

(51) Int. Cl. F26B 5/12

(52) U.S. Cl. CPC F26B 5/12
USPC 34/499; 34/92

(57) ABSTRACT

The invention relates to a device for treating a material (20), in particular for drying a preferably strip-shaped material (20), comprising a gaseous treatment medium which flows through the material (20), at least one drum (2) which comprises a gas-permeable drum cover (21) which is at least partially covered with the material (20) which can be transported in the peripheral direction of the drum (2) inside (18) where a negative pressure can be set, a treatment chamber (14, 76, 78) surrounding the drum (2). When setting the negative pressure in the inside (18) of the drum (2), at least part of the gaseous treatment medium flows out from the treatment chamber (14, 76, 78) through the material (20) arranged on the drum cover (21) and through the gas-permeable drum cover (21) into the inside of the drum (2). At least one guide plate (4) is arranged in the treatment chamber (14, 76, 78) of the drum (2) so that said treatment chamber (14, 76, 78) is subdivided into at least two channels (11, 12, 13), the at least one guide plate (4) being arranged in such a manner that the at least two channels (11, 12, 13) extend along the periphery of the drum (2).

The invention relates to a device for treating a material, in particular for drying a preferably strip-shaped material, with a gaseous treatment medium according to the preamble of claims 1, 4, 8, 15, 16 and 17 as well as a method of treating a material, in particular drying a preferably strip-shaped material, according to claims 10, 11 and 12

In the previously known devices for treating a material, in particular for drying a strip-shaped material, with a gaseous treatment medium, a drum is arranged in a housing. The drum has a gas-permeable drum casing, wherein the drum casing is at least partially covered with the material adapted to be transported in the peripheral direction of the drum, and wherein a negative pressure is adapted to be applied in the inside of the drum. The drum is at least partially surrounded by a treatment chamber, wherein, when a negative pressure is applied in the inside of the drum, at least part of the gaseous treatment medium flows from the treatment chamber through the material arranged on the drum casing and through the gas-permeable drum casing into the inside of the drum.

However, the previously known devices are disadvantageous in that flows occur in the treatment chamber which cause the material to be dried to experience a poor drying uniformity during the drying process. Further, there is the problem that the previously known devices require a lot of energy.

It is therefore an object of the present invention to provide a device and a method in which the drying uniformity of the material to be dried can be increased and in which the energy consumption can be reduced.

This object is achieved by the features of claims 1, 4, 8, 10, 11, 14, 15, 16, and 17

The invention advantageously provides for at least one guide plate to be disposed in the treatment chamber of the drum such that the treatment chamber can be subdivided into at least two channels, wherein the at least one guide plate is arranged such that the at least two channels extend along the periphery of the drum.

The invention thus offers the advantage that the flows in the axially parallel direction to the drum can be prevented.

The at least one guide plate may be arranged at a distance to the drum, wherein the guide plate comprises an end edge facing the drum.

The at least one guide plate may be arranged such that the end edge of the guide plate along the periphery of the drum has a constant distance to the drum casing of the drum.

The distance from the end edge of the guide plate to the drum casing of the drum may range between 10 and 150 mm, preferably between 30 and 80 mm. At this distance, the flows can be most effectively avoided.

The distance between the material arranged on the drum casing of the drum and the end edge of the least one guide plate may range between 10 and 50 mm.

The width of the channels may have the same size, wherein the width of the channels is the extension of the channels in the axially parallel direction of the drum. If the channels are of the same width it can be ensured that the flow in the channels is the same to the extent possible. Alternatively, however, it can also be provided for the channels to have a different width.

By adjusting the at least one guide plate the width of channels can be adjustable, wherein the width of the channels is the extension of the channels in the axially parallel direction.

At least two guide plates may be arranged in the treatment chamber. By adjusting the at least two guide plates the width of the treatment chamber surrounding the drum can be adjustable. The width of the treatment chamber is the extension of the treatment chamber in the axially parallel direction of the drum.

The working width of the drum corresponds to the width of the material which is arranged on the drum casing. The at least two guide plates may be adjustable such that the width of the treatment chamber is adaptable to the working width of the drum. The width of the treatment chamber and the working width of the drum are the extension of the treatment chamber and the extension of the working width of the drum, respectively, in the axially parallel direction of the drum.

The adaptability of the width of the treatment chamber to the working width of the drum offers the advantage that the flow can better pass through the strip-shaped material.

The guide plates defining the treatment chamber in the axially parallel direction of the drum may comprise a respective sealing lip at the end edge facing the drum, such that the sealing lip rests on the drum casing thereby ensuring that the gaseous treatment medium of the treatment chamber can exit the treatment chamber only through the gas-permeable drum casing.

A feeding means may feed the gaseous treatment medium in a manner distributed across the working width of the drum to the treatment chamber.

The invention may advantageously provide for a feeding means for feeding the gaseous treatment medium in a manner distributed across the width of the drum to the treatment chamber in a peripheral region of the drum, wherein the width of the drum is the extension of the drum in the axially parallel direction of the drum. The feeding means may comprise a feeding channel through which the gaseous treatment medium to be fed to the treatment chamber flows A perforated plate may be arranged in the cross section of the feeding channel, whose gas permeability can be varied.

This offers the advantage that by means of the variable gas permeability of the perforated plate the optimum volumetric flow of the gaseous treatment medium is adapted to be fed to the treatment chamber.

The feeding means can feed the gaseous treatment medium in a manner distributed across the width of the drum to the treatment chamber in a peripheral region of the drum. The working width of the drum is the extension of the working width in the axially parallel direction.

The perforated plate may have a varying gas permeability across its width, wherein the width of the perforated plate is the extension of the perforated plate in the axially parallel direction. The gaseous treatment medium which flows through the perforated plate at a particular location across the width of the perforated plate, flows into the treatment chamber at the corresponding location. If the gas permeability is changed at the location of the perforated plate, the volumetric flow that flows into the treatment chamber at the corresponding location is changed.

The gas permeability varying across the width of the perforated plate may be independently adjustable.

The gas permeability of the perforated plate may be varied by the number of open holes in the perforated plate, the hole shape or the distribution of the holes.

At least one drum guide element may be arranged inside the drum, wherein the at least one drum guide element is connected with the drum at least in the vicinity of an end wall of the drum, wherein the at least one drum guide element is arranged such that the negative pressure which is applied to the drum casing is uniformized.

The drum guide element may have the shape of a truncated cone and the drum guide element can, with its side having the larger radius, be connected with the drum in the inside of the drum, and the truncated casing of the truncated drum elements may protrude into the inside of the drum.

This offers the advantage that, if in the region of an end wall of the drum a fan for generating the negative pressure is arranged, the negative pressure applied to the gas-permeable drum casing is uniformized due to the provision of these drum guide plates. Otherwise, the negative pressure in the region of the end wall where the negative pressure is generated is increased.

According to the present invention, it can be advantageously provided for the treatment chamber to be subdivided by partition plates into at least two treatment subchambers. At least a first treatment subchamber may surround at least a first peripheral region of the drum and a second treatment subchamber may surround at least a second peripheral region of the drum. A first gaseous treatment medium having a first temperature is adapted to be introduced into the first treatment subchamber and a second gaseous treatment medium having a second temperature is adapted to be introduced into the second treatment subchamber.

The first temperature of the first gaseous treatment medium is preferably higher than the temperature of the second gaseous treatment medium. Further, it may also be provided for the volumetric flow of the first gaseous treatment medium which is introduced into the first treatment subchamber to be larger than the volumetric flow of the second gaseous treatment medium which is introduced into the second treatment subchamber. This means that the flow of the first gaseous treatment medium through the material in the region of the first treatment subchamber is larger than the flow of the second gaseous treatment medium through the material in the region of the second treatment subchamber.

A wet, preferably strip-shaped, material which is adapted to be transported in the peripheral direction of the drum dries to the largest extent in the first peripheral region of the drum, i. e. shortly after having entering the drying chamber. After the material to be dried has already lost a lot of water, it dries more slowly in the following peripheral region. The present invention offers the advantage that in the first region in which the material dries very quickly there may be a higher temperature and/or through-flow than in the region in which the material is no longer drying quickly. This offers the advantage that at a constant degree of drying the required drying energy is reduced or at an increased degree of drying the required drying energy is constant.

The second peripheral region of the drum which is surrounded by at least a portion of the second treatment subchamber is arranged downstream of the first peripheral region of the drum, as seen in the transport direction of the strip-shaped material, which is surrounded by at least a portion of the first treatment subchamber.

According to the present invention, a method of treating a material, in particular drying a preferably strip-shaped material, is provided, the method comprising the following method steps:
feeding a gaseous treatment medium into a treatment chamber including at least two channels, wherein the treatment chamber at least partially surrounds a drum including a gas-permeable drum casing, wherein a strip-shaped material is at least partially arranged on the drum casing,
directing the gaseous treatment medium in the peripheral direction of the drum by means of the at least two channels,
discharging the gaseous treatment medium in the inside of the drum such that at least part of the gaseous treatment medium flows through the material arranged on the drum casing and the gas-permeable drum casing.

Further, according to the present invention, a method of treating a material, in particular drying a preferably strip-shaped material, is provided, the method comprising the following method steps:
feeding a gaseous treatment medium into a treatment chamber, wherein the treatment chamber at least partially surrounds the drum including a gas-permeable drum casing, wherein a strip-shaped material is at least partially arranged on the drum casing,
discharging the gaseous treatment medium in the inside of the drum such that at least part of the gaseous treatment medium flows through the material arranged on the drum casing and the gas-permeable drum casing, wherein the gaseous treatment medium is fed in a manner distributed across the width of the drum to the treatment chamber at a peripheral region of the drum, wherein the width of the drum corresponds to the extension of the drum in an axially parallel direction,
wherein the volumetric flow of the fed gaseous treatment medium can be varied.

A different volumetric flow of the gaseous treatment medium can be fed in a manner distributed across the width of the drum.

In the peripheral regions of the drum a higher volumetric flow of the gaseous treatment medium can be fed than in the center of the drum. This offers the advantage that the edge regions of the strip-shaped material to be dried that are wetter than the central portions of the strip-shaped material can be dried better.

According to the present invention, a method of treating a material, in particular drying a preferably strip-shaped material, is provided, the method comprising the following method steps:
arranging a strip-shaped material on a gas-permeable drum casing of a drum and transporting the strip-shaped material in the peripheral direction of the drum,
feeding at least a first gaseous treatment medium having a first temperature to a first portion of the material which is arranged on the drum casing,
feeding at least a second gaseous treatment medium having a second temperature to a second portion of the material which is arranged on the drum casing,
wherein the second portion is arranged downstream of the first portion as seen in the transport direction of the material,
discharging the gaseous treatment medium in the inside of the drum such that at least part of the first and second gaseous treatment media flows through the material arranged on the drum casing and the gas-permeable drum casing.

Further, in the prior art, a device for drying a preferably strip-shaped material is frequently provided with a shielding element. In the prior art, the shielding element is disposed in the inside of the drum relative to the drum such that the flow of a gas through the drum casing in the peripheral region of the drum that is not surrounded by the strip-shaped material is reduced or prevented.

According to the present invention, it is advantageously provided that the shielding element is arranged outside the drum, wherein the shielding element is arranged relative to the drum such that the flow of a gas through the drum casing in the peripheral region of the drum that is not surrounded by the strip-shaped material is reduced or preferably prevented. This offers the advantage that the gas permeability is also reduced and can preferably be completely suppressed, with the shielding element being substantially easier to install. Furthermore, it can also be more easily replaced.

In previously known devices for drying a preferably strip-shaped material with a gaseous treatment medium the drum adapted to rotate about a drum axis comprises a first and a second end wall, wherein in the first and second end walls a respective first and second drum hub is disposed. The drum can be driven via the drum hubs with the aid of at least one drive shaft, for example, such that the drum rotates.

According to the present invention, is advantageously provided for at least one drum hub to be arranged in the axial direction of the drum and offset to the outside relative to the drum. In one of the end walls of the drum an opening is provided for discharging the gaseous treatment medium from the drum inside. Since at least one drum hub is arranged in the axial direction of the drum and offset to the outside relative to the drum, the opening can be enlarged such that the gaseous treatment medium can be better discharged from the inside of the drum.

Hereunder exemplary embodiments of the invention will be explained in detail with reference to drawings. The drawings schematically show:

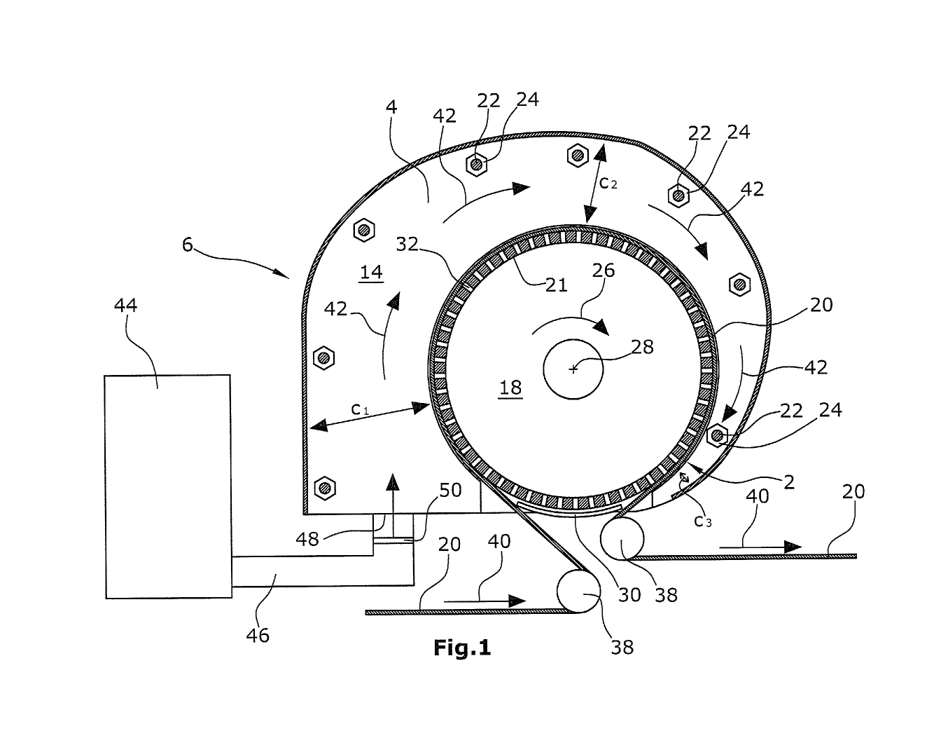

FIG. 1 a device for treating a material, in particular for drying a preferably strip-shaped material,

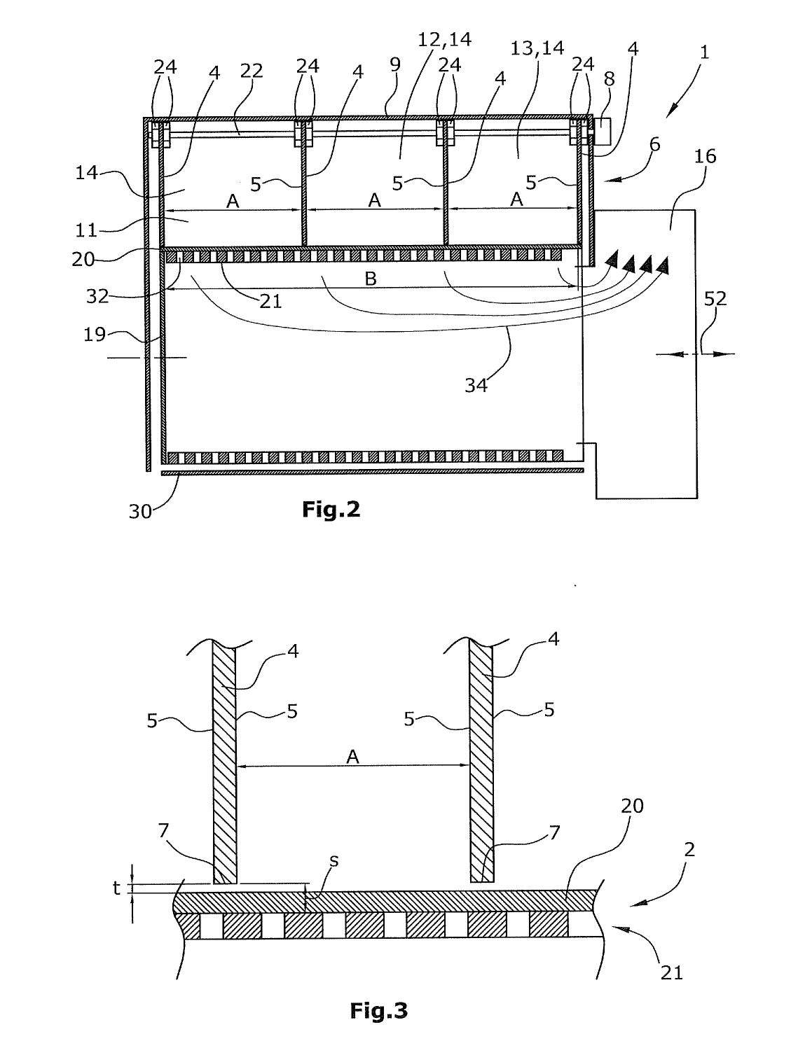

FIG. 2 a sectional view of the device of FIG. 1,

FIG. 3 a detailed view of FIG. 2,

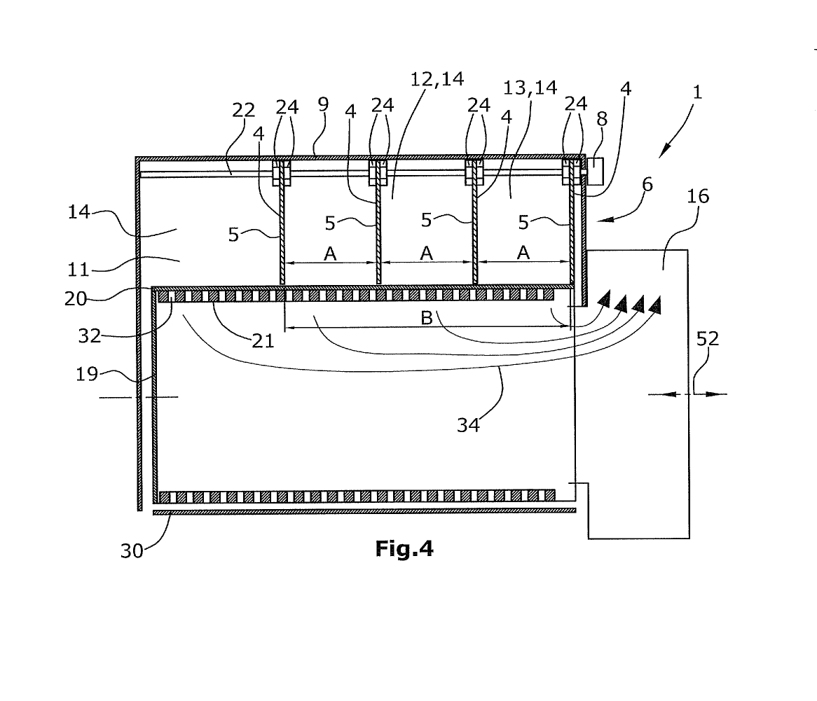

FIG. 4 the exemplary embodiment of FIG. 2 with adjusted guide plates,

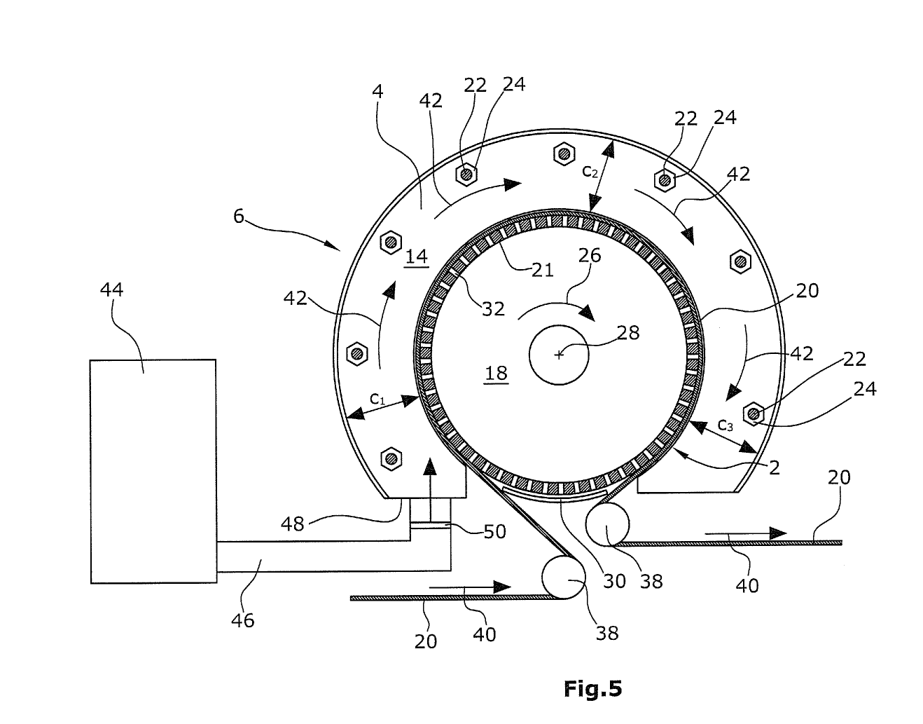

FIG. 5 another exemplary embodiment,

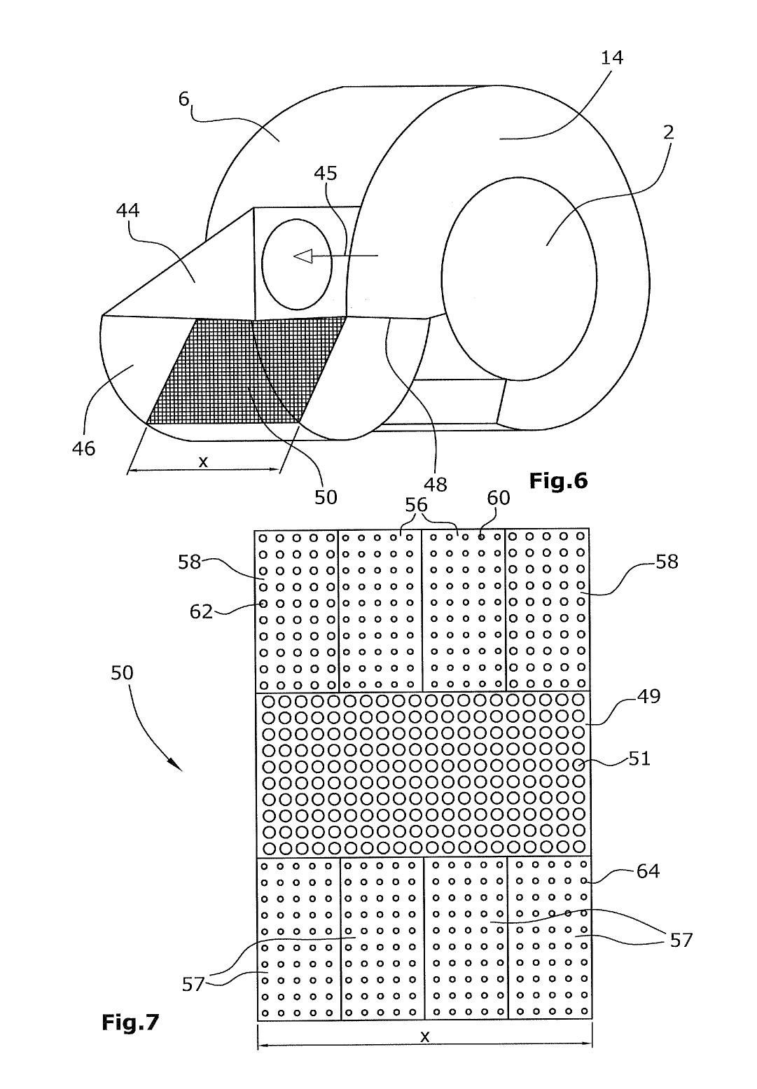

FIG. 6 another exemplary embodiment,

FIG. 7 a perforated plate with adjustable gas permeability,

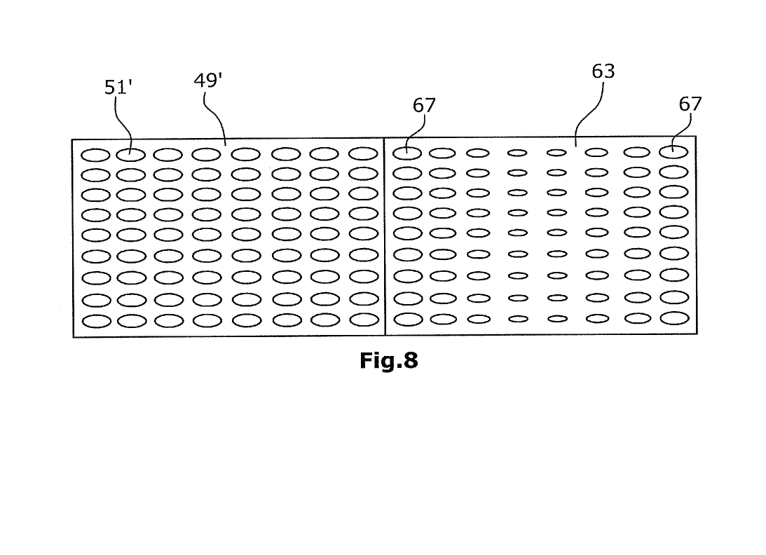

FIG. 8 another perforated plate with adjustable gas permeability,

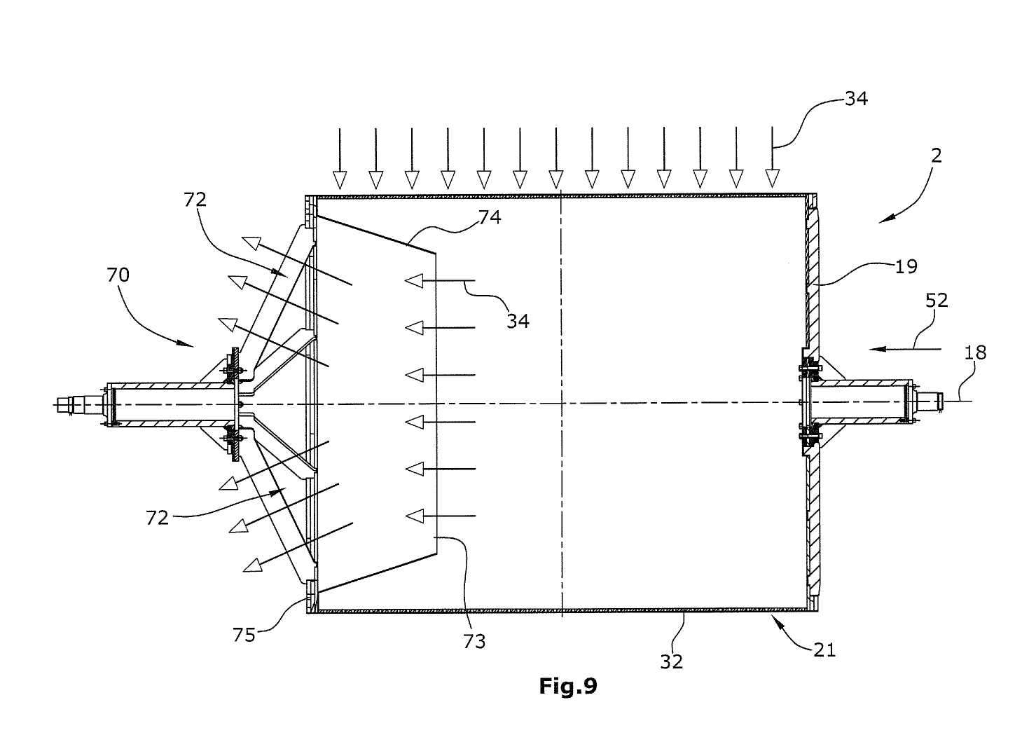

FIG. 9 a drum with drum guide elements,

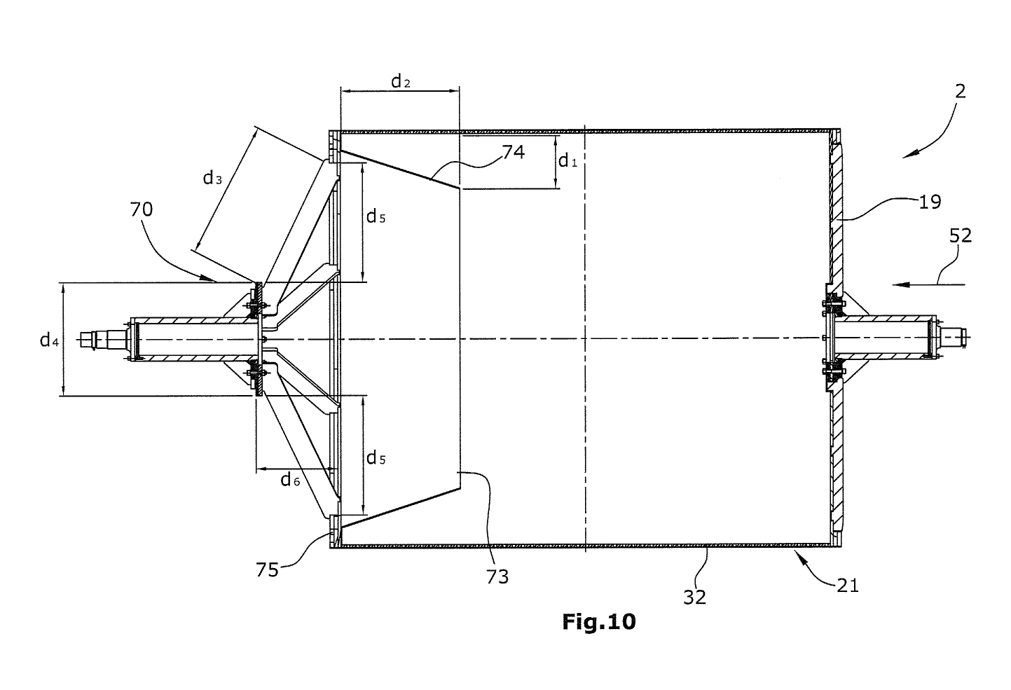

FIG. 10 a drum of FIG. 9,

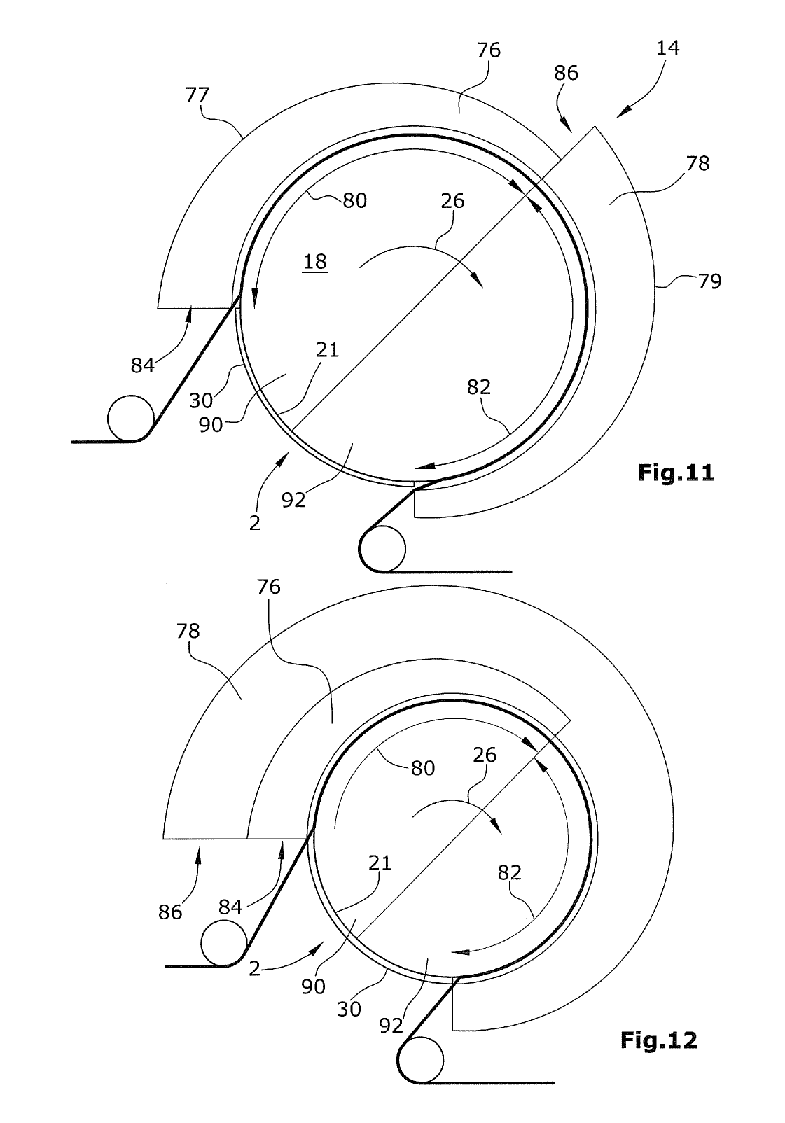

FIG. 11 an exemplary embodiment with treatment subchambers,

FIG. 12 another exemplary embodiment with treatment subchambers.

FIG. 1 shows a device for treating a material, in particular for drying a preferably strip-shaped material 20. The device comprises a housing 6. In the housing 6 a drum 2 is arranged. The drum 2 is gas-permeable. The drum 2 is gas-permeable due to the perforations 32 in the drum casing 21. The drum 2 is rotatable in the rotational direction 26 about the drum axis 28. The drum axis 28 is supported in the housing 6. This is not shown in the Figures. The drum is surrounded by a treatment chamber 14. This can also be seen in FIG. 2.

The strip-shaped material 20 is inserted into the treatment chamber 14 via a deflection roller 38 in the transport direction 40. The strip-shaped material 20 is arranged at least on a portion of the drum casing 21. By rotating the drum 2 in the rotational direction 26 of the drum, the strip-shaped material 20 is transported in the transport direction 40. The strip-shaped material 20, when exiting the treatment chamber 14, is guided by another deflection roller 38 and further transported in the transporting direction 40.

In the peripheral region of the drum 2, in which the drum casing 21 is not covered by the strip-shaped material, a shielding element 30 is arranged. The shielding element 30 is disposed outside the drum 2 and can therefore be easily mounted and replaced. The shielding element 30 can prevent a gas from entering the drum in the region of the shielding element 30 through the drum casing. In the region of the shielding element 30 the flow of the gaseous treatment medium or ambient air is thus reduced and preferably completely prevented. This offers the advantage that the strip-shaped material, once it has reached the peripheral region in which the shielding element 30 is disposed, can easily be detached from the drum casing 21.

In the treatment chamber 14 a gaseous treatment medium is introduced via a feeding means 44 via a feeding channel 46 and a feeding opening 48. The gaseous treatment medium is preferably heated air.

As is shown in FIG. 2, the inside of the drum is closed at one end face by an end wall 19. At the opposite end face an expansion chamber 16 is arranged. In this expansion chamber 16 a negative pressure is applied, whereby a negative pressure is generated in the drum inside 18. Thus the gaseous treatment medium present in the treatment chamber 14 is drawn through the gas-permeable strip-shaped material 20 and the gas-permeable drum casing 21 into the drum inside 18. From the drum inside 18 the gaseous treatment medium is drawn into the expansion chamber 16. The flow direction is indicated by the arrows 34.

From the expansion chamber 16, the gaseous treatment medium can be fed to an air processing system and reprocessed and heated and returned to the treatment chamber 14 via the feeding means 44.

Since in the drum inside 18 a negative pressure is applied, the strip-shaped material 20 is drawn to the drum casing 21 and can thus be transported via the rotation of the drum 2 in the transport direction 40. Further, the wet strip-shaped material 20 dries since the gaseous treatment medium flows through the strip-shaped material 20.

As can be seen from FIG. 2, four guide plates 4 are disposed in the treatment chamber 14. The guide plates 4 divide the treatment chamber into three channels 11, 12, 13, wherein the guide plates 4 are arranged such that the three channels 11, 12, 13 extend along the periphery of the drum 2. Thus the treatment medium flows in the flow direction 42 inside the channels 11, 12 and 13.

The flow direction of the gaseous treatment medium thus extends substantially parallel to the rotational direction 26 of the drum. The main surfaces 5 of the guide plates 4 extend in the radial direction relative to the drum.

The width of the channels 11, 12, 13 is preferably of the same size. The width A of the channels 11, 12, 13 is the extension of the channels 11, 12, 13 in the axially parallel direction of the drum, i. e. in a direction parallel to the axis 28 of the drum 2. Via the guide plates 4 a flow in the axially parallel direction is prevented. In this way, use of the sieve covers normally employed in the prior art is not necessary. Thus a simple construction is possible.

The guide plates 4 can be adjusted in axially parallel direction 52. In the treatment chamber threaded rods 22 are arranged in a manner distributed across the periphery and extend parallel to the drum axis 28. The guide plates 4 are connected with nuts 24 which are respectively screwed onto the threaded rods 22. The threaded rods can be rotated with the aid of adjusting units 8, thereby moving the nuts 24 fixedly connected with the guide plates 4 along the threaded rods 22 in the axially parallel direction 52, whereby the guide plates 4 are adjustable in the axially parallel direction 52.

By adjusting the guide plates 4 in the axially parallel direction the width of the channels 11, 12 and 13 can be adjusted. The guide plates 4 are adapted to be individually or jointly adjustable. Alternatively, the guide plates may be manually adjustable. In FIG. 4 the guide plates 4 are adjusted in the axially parallel direction relative to the representation shown in FIG. 2. The width A of the channels 11, 12 and 13 is smaller than the width A of the channels 11, 12 and 13 in FIG. 2.

The guide plates 4 comprise an end edge 7. The end edge 7 and the guide plates 4 are each spaced apart from the drum casing 21. The distance to the drum casing 21 is preferably constant along the periphery. The distance to the drum casing preferably ranges between 10 and 150 mm. Particularly preferred is a distance of 30 to 80 mm. The distance between the end edge 7 and the material 20 arranged on the drum casing 21 is preferably 10 to 50 mm. These distances are optimal to prevent flows.

By adjusting the guide plates 4 in the axially parallel direction 52 the width of the treatment chamber 14, through which the gaseous treatment medium flows, can be adjusted. The width of the treatment chamber is indicated by D in FIG. 2. The treatment chamber 14 is defined in the axially parallel direction 52 by the guide plates 4 which are the outer guide plates in the axially parallel direction.

The strip-shaped material 20 has a width B. The width B of the strip-shaped material 20 on the drum 2 is the extension of the strip-shaped material 20 in the axially parallel direction 52. The width of the strip-shaped material 20 corresponds to the working width B of the drum 2. The width D of the treatment chamber 14 can be adapted to the working width B of the drum 2. Both in FIG. 2 and in FIG. 4 the width D of the treatment chamber 14 is adapted to the working width of the drum 2. This ensures that the strip-shaped material is guided only in the region along the periphery of the drum 2, in which the strip-shaped material 20 is disposed. Thus it can be ensured that the gaseous treatment medium constantly flows through the strip-shaped material 20 via the working width. Furthermore, energy can be saved in this way since the entire gaseous treatment medium flows through the material and does not flow in an unused manner through the drum in the region of the drum which is not covered by the material.

FIG. 1 shows a perforated plate 50 disposed in the feeding channel 46. The feeding channel 46 and the feeding opening 48 have a width extending in the axially parallel direction 52. The width of the channel 46 and the feeding opening 48 corresponds to the width of the treatment chamber 14. Thus the gaseous treatment medium can be fed in a manner distributed across the width of the drum 2 to the treatment chamber 14. The perforate plate 50 arranged in the feeding channel 46 also has a width that extends in the axially parallel direction and corresponds to the width of the drum 2.

The gas permeability of the perforated plate 50 can be adjustable. Likewise, the gas permeability of the perforated plate 50 across the width of the perforated plate 50 may be adjustable in a different manner. In this way, the volumetric flow of the gaseous treatment medium to be fed can be varied by varying the gas permeability of the perforated plate 50. Thus in a wetter nonwoven a higher volumetric flow is required. Since the volumetric flow can be adapted to the respective conditions, energy can be saved. Likewise, the volumetric flow of the treatment medium to be fed, in a strip-shaped material 20 which is wetter at the edges than in the middle, for example, can be varied such that the volumetric flow in the edge region of the drum and thus the edge region of the treatment chamber 14 in the axially parallel direction is set higher than in the middle of the drum or the treatment chamber 14. This is shown in more detail in FIG. 6.

The exemplary embodiment in FIGS. 1 to 4 further comprises a treatment chamber 14 which is defined in a radially outward direction by the housing wall 9. The distance between the housing wall 9 and the drum casing 21 decreases in the transport direction 40 and/or the rotational direction 26 of the drum 2. The distance C1, C2, C3 preferably decreases continuously.

In FIG. 5 an exemplary embodiment is shown, in which the distances C1, C2, C3 are of equal magnitude.

FIG. 6 schematically shows another exemplary embodiment of feeding the gaseous treatment medium into the treatment chamber 14. The drum 2, the housing 6, the treatment chamber 14 and the feeding means 44 are shown only schematically.

The heated gaseous treatment medium 45 is introduced into the feeding means 44. The feeding means 44 feeds the gaseous treatment medium 45 to the treatment chamber 14 through the feeding channel 46 and the feeding opening 48. The gaseous treatment medium 45 is preferably tangentially introduced into the treatment chamber 14. The width of the feeding opening 48, as seen in the axially parallel direction, is as wide as the width of the drum. The width of the feeding channel 46 in the axially parallel direction corresponds to the width of the drum 2. In the cross section of the feeding channel 46 a perforated plate 50 is arranged which also has a width in the axially parallel direction which corresponds to the width of the drum 2. The gas permeability of the perforated plate to the width of the drum 2. The gas permeability of the perforated plate 50 is adjustable. This offers the advantage that the volumetric flow of the gaseous treatment medium to be fed is adjustable. The gas permeability of the perforated plate 50 can preferably be differently set via the width X. This can be done by exemplary embodiments illustrated in FIGS. 7 and 8, for example.

FIG. 7 shows a perforated plate 50 comprising a first plate element 49. The plate element 49 comprises holes 51 distributed across the width X. Further, the perforated plate comprises different sliding elements 56, 57, 58 distributed across the width X, which can be pushed in front of the respective region of the first plate element 49. These sliding elements 56, 57, 58 also comprise holes 60, 62, 64. Either the sliding elements 56 and 58 or the sliding elements 57 can be moved in front of the perforated plate, for example.

The diameters of the holes 60, 62, 64 of the sliding elements 56, 58 and 57 are each smaller than the holes 51 of the first plate element 49. The holes 60, 62 and 64, respectively, of the sliding elements 56, 58 and 57, respectively, are arranged such that, when the sliding elements 56, 58, and 57, respectively, are pushed in front of the perforated plate 50, the holes are arranged at the same locations as the holes 51 of the first plate element 49.

The gaseous treatment medium has to pass through the holes 51 of the first plate element 49 to be capable of flowing into the treatment chamber 14. When the sliding elements 56, 58 and 57, respectively, are pushed in front the perforated plate 50, the effective diameter of the holes through which the gaseous treatment medium must pass is reduced since the holes 60, 62 and 64, respectively, are smaller than the holes 51.

The holes 62 of the sliding elements 58 have a larger diameter than the holes 60 of the sliding elements 56. The sliding elements 58 are arranged in the edge region of the first plate element 49. Thus the volumetric flow of the perforated plate 50 would be higher in the edge region than in the central region if the sliding elements 56 and 58 were pushed in front of the first perforated plate element 49.

The holes 64 of the sliding elements 57 are all of the same size. If the sliding elements 57 are pushed in front of the first plate element 49, merely the entire volumetric flow across the width X of the perforated plate 50 is reduced.

Alternatively, as shown in FIG. 8, a sliding element could be pushed in an axially parallel direction in front of the first plate element 49′. The first plate element 49′ comprises holes 51 having an elliptical shape. The sliding element 63 comprises holes of different diameters, wherein the holes 67 which are located in the edge area in axial direction are larger than the holes 67 in the central region of the sliding element 63.

The holes in the edge region of the sliding element 63 have the same size as the holes 51′ of the first plate element 49′. The holes 67 of the sliding element 63 are arranged such that the centers of the respective holes 67 are disposed directly in front of the centers of the holes 51′ of the first plate element when the sliding element 53 is pushed in front of the first plate element 49. Since the holes in the central region of the sliding element 63 are smaller, the perforated plate 50 has a lower gas permeability in the central region when the sliding element 63 is pushed in front of the first plate element 49′. The size of the holes 67 continuously decreases towards the center.

In FIG. 9 a drum 2 is shown. This drum 2 can be used in the exemplary embodiments of FIGS. 1 to 8. Alternatively, this drum can also be used with any other drier. The drum is a gas-permeable drum 2, wherein the drum casing 21 comprises perforations 32. Thus a gaseous medium can pass through the drum casing. This is indicated by the arrows 34. At one end face of the drum 2 an end wall 19 is arranged which closes the drum 2. At the opposite end face the end wall of the drum 2 is open such that the gaseous medium can exit the inside of the drum through this end wall. In a commonly used drier or a drier according to any one of the exemplary embodiments 1 to 8, an expansion chamber is arranged on this side.

In the prior art, the drum hub of the drum is arranged inside the end wall. In the drum according to the present invention, the drum hub 70 is disposed outside the drum in the axial direction 52 of the drum and thus offset relative to the end wall. Thus the outlet area D3 shown in FIG. 10 can be increased. The gaseous treatment medium can exit the drum only through the outlet opening 72.

Further, a drum guide element 74 is arranged at the end face of the drum where the outlet opening 72 is arranged. This drum guide element 74 has a conical shape. However, it could also have any other shape. The drum guide element is arranged close to the end wall 75 comprising the outlet opening 72. In this case the drum guide element 74 is fixed to the end wall 75. However, the drum guide element 74 could also be fastened to the drum casing 21 near the end wall 75.

Since the drum guide element 74 is provided, the gaseous treatment medium which flows through the drum casing 21 near the end wall 75 first has to flow into the drum inside to then reach the outlet opening 72 through the opening 73 of the drum guide element. Consequently, the gaseous treatment medium passes in a more uniformly distributed manner through the drum casing 21 since the negative pressure prevailing in the drum inside is more uniformly distributed across the drum casing 21. Otherwise, since the negative pressure is produced in the expansion chamber adjacent to the outlet opening 72, said negative pressure would be higher in the region of the drum casing which is arranged in the vicinity of the outlet opening 72.

FIG. 10 shows that, since the drum hub 70 is disposed outside the end wall 75 in the axial direction, the outlet opening 72 is enlarged.

FIG. 11 shows a device having a first and a second treatment subchamber 76 and 78, respectively. The treatment chamber 14 is the chamber which surrounds the drum 2 in the region where the strip-shaped material 20 is disposed. In the region in which the strip-shaped material is not disposed a shielding element 30 is arranged, as described above.

In the present exemplary embodiment shown in FIG. 11, the treatment chamber 14 is subdivided into a first and a second treatment subchamber 76 and 78, respectively. The first treatment subchamber 76 is defined by the housing wall 77 in radial direction towards the outside. A first gaseous treatment medium 84 enters the first treatment subchamber 76, said gaseous treatment medium having a first temperature. The second treatment subchamber 78 surrounds the drum in a second peripheral region 82. The second treatment subchamber 78 is defined by the housing wall 79 in radial direction towards the outside. The drum 2 rotates in the rotational direction 26, however, the peripheral regions 80 and 82 are always at the same location relative to the housing walls 77, 79. The strip-shaped material is entrained by the drum 2 in the rotational direction and surrounds the drum in the peripheral regions 80 and 82

A second gaseous treatment medium 86 flows into the second treatment chamber 78. In this way, in the first peripheral region 80 the drum is surrounded by a first treatment medium having a first temperature and in the second peripheral region 82 the drum 2 is surrounded by a second gaseous treatment medium 86 having a second temperature. The second peripheral region 82 is disposed downstream of the peripheral region 80 in the transport direction of the material.

The first temperature of the first gaseous treatment medium 84 is preferably higher than the second temperature of the second gaseous treatment medium 86. Further, the volumetric flow of the first gaseous treatment medium 84 which flows through the material in the first peripheral region 80 is preferably higher than the volumetric flow of the second gaseous treatment medium 86 which flows through the material in the second peripheral region 82. In this way the strip-shaped material which first passes through the first peripheral region 80 is quickly dried. In the second peripheral region 82 it is not essential for the drying of the material if the temperature and/or the volumetric flow of the second gaseous treatment medium are high. The wetter the material to be dried, the higher is the effect of the temperature and/or the volumetric flow at which a wet material is dried. In the peripheral region 82 the material is drier than in the peripheral region 80. In the peripheral region 82 the level of the temperature and/or the magnitude of the volumetric flow have no great influence on the drying rate of the strip-shaped material. Therefore the temperature and/or the volumetric flow of the second gaseous treatment medium 86 may be lower than the first temperature and/or the volumetric flow of the first gaseous treatment medium temperature and/or the volumetric flow of the first gaseous treatment medium 84. In this way energy is saved.

Alternatively, the second temperature and/or the volumetric flow of the second gaseous treatment medium 86 may be higher than the first temperature and/or the volumetric flow of the first gaseous treatment medium 84.

FIG. 12 shows another exemplary embodiment with a first and a second treatment chamber 76 and 78, respectively. This exemplary embodiment differs in that the second treatment subchamber not only surrounds the drum 2 in the peripheral area 82, but also the first treatment subchamber at the side of the treatment subchamber which is not adjacent to the drum 2. The second treatment subchamber 78 thus surrounds the housing wall 77 of the first treatment subchamber. In this way, the second gaseous treatment medium 86 which is introduced into the second treatment subchamber 78 is first guided past the housing wall 77 of the first treatment subchamber before it enters the region of the second treatment subchamber 78 which partially surrounds the drum 2.

In this way, when the first temperature is higher than the second temperature, the gaseous treatment medium 86 is preheated by the waste heat of the first treatment subchamber 76.

The drum 2 can be subdivided into a first and a second drum subchamber 90, 92 in the inside 18, wherein the first drum subchamber is arranged in the first peripheral portion 80 of the drum and the second drum subchamber is arranged in the second peripheral portion 82 such that the first gaseous treatment medium 84 which enters the drum inside 18 through the drum casing 21 enters the first drum subchamber 90, and the second gaseous treatment medium 86 which passes through the drum casing enters the second drum subchamber. The respective first and second gaseous treatment media 84, 86 that have entered the first and second subchambers, respectively, can be separately returned and heated and can be supplied with fresh air and can then enter again the first and second treatment subchambers, respectively.

In the exemplary embodiments of FIGS. 11 and 12, the first and second treatment subchambers may each comprise channels, as described in FIGS. 1 to 5.

In addition, further treatment subchambers, e. g. a third or a fourth treatment subchamber, may be provided, each surrounding the drum in a peripheral region which is adjacent to the first and second peripheral regions in the transport direction of the material. Gaseous treatment media having different temperatures may be introduced into these treatment subchambers.

1-17. (canceled)

18. A device for treating a material, in particular for drying a preferably strip-shaped material, with a gaseous treatment medium which flows through the material, comprising
at least one drum including a gas-permeable drum casing, wherein said drum casing is at least partially covered with said material adapted to be transported in the peripheral direction of said drum, and wherein in an inside of said drum a negative pressure is adapted to be applied,
a treatment chamber at least partially surrounding said drum, wherein upon application of the negative pressure in said inside of said drum at least part of the gaseous treatment medium flows from said treatment chamber through said material arranged on said drum casing and through said gas-permeable drum casing into the inside of said drum, wherein
at least one guide plate is arranged in the treatment chamber of said drum such that said treatment chamber is adapted to be subdivided into at least two channels, wherein said at least one guide plate is arranged such that said at least two channels extend along the periphery of said drum.

19. The device according to claim 18, wherein at least two guide plates are arranged in the treatment chamber and wherein by adjusting said at least two guide plates the width of said treatment chamber surrounding said drum is adjustable, wherein the width of said treatment chamber is the extension of said treatment chamber in an axially parallel direction.

20. The device according to claim 19, wherein the working width of the drum corresponds to the width of the material arranged on the drum casing of said drum, and wherein the at least two guide plates are adjustable such that the width of the treatment chamber is adaptable to the working width of said drum, wherein the width of said treatment chamber and the working width of said drum are the extension of said treatment chamber and the extension of the working width of said drum, respectively, in the axially parallel direction.

21. A device for treating a material, in particular drying a preferably strip-shaped material, with a gaseous treatment medium which flows through the material, comprising
at least one drum rotatable about a drum axis and including a gas-permeable drum casing, wherein said drum casing is at least partially covered with said material adapted to be transported in the peripheral direction of said drum, and wherein in an inside of said drum a negative pressure is adapted to be applied,
a treatment chamber at least partially surrounding said drum, wherein upon application of the negative pressure in said inside of said drum at least part of the gaseous treatment medium flows from said treatment chamber through said material arranged on said drum casing and through said gas-permeable drum casing into the inside of said drum, wherein
a feeding means feeds the gaseous treatment medium in a manner distributed across the width of said drum in a peripheral region of said drum to said treatment chamber, wherein the width of said drum is the extension of said drum in an axially parallel direction,
said feeding means includes a feeding channel through which the gaseous medium to be fed to said treatment chamber flows, wherein
a perforated plate is arranged in the cross section of said feeding channel, whose gas permeability is adapted to be varied.

22. The device according to claim 21, wherein the feeding means feeds the gaseous treatment medium in a manner uniformly distributed across the working width of said drum to the treatment chamber in a peripheral region of said drum, wherein the working width of said drum is the extension of the working width in the axially parallel direction.

23. The device according to claim 21, wherein the perforated plate has a varying gas permeability distributed across the width, wherein the width of said perforated plate is the extension of said perforated plate in the axially parallel direction.

24. The device according to claim 18, wherein at least one drum guide element is arranged in the inside of the drum, wherein the at least one drum guide element is connected with said drum in the vicinity of at least one end wall of said drum, wherein said at least one drum guide element is arranged such that the negative pressure applied to the drum casing is uniformized.

25. A device for treating a material, in particular drying a preferably strip-shaped material, with a gaseous treatment medium which flows through the material, comprising
at least one drum including a gas-permeable drum casing, wherein said drum casing is at least partially covered with said material, and wherein in an inside of said drum a negative pressure is adapted be applied,
a treatment chamber at least partially surrounding said drum, wherein upon application of the negative pressure in said inside of said drum the gaseous treatment medium flows from said treatment chamber through said material arranged on said drum casing and said drum casing into the inside of said drum, wherein
said treatment chamber is subdivided by partition plates into at least two treatment subchambers, wherein at least a first treatment subchamber surrounds at least a first peripheral region of said drum and a second treatment subchamber surrounds at least a second peripheral region of said drum, wherein a first gaseous treatment medium having a first temperature is adapted to be introduced into said first treatment subchamber, and wherein a second gaseous treatment medium having a second temperature is adapted to be introduced into said second treatment subchamber.

26. The device according to claim 25, wherein the first temperature of the first gaseous treatment medium is higher than the second temperature of the second gaseous treatment medium and/or the volumetric flow of said first treatment medium is larger than the volumetric flow of said second treatment medium, and wherein the second peripheral region of the drum which is surrounded by at least a portion of said second treatment subchamber is arranged downstream of said first peripheral region of said drum as seen in the transport direction of said strip-shaped material, said first peripheral region being surrounded by at least a portion of said first treatment subchamber.

27. A method of treating a material, in particular drying a preferably strip-shaped material, comprising
feeding a gaseous treatment medium into a treatment chamber including at least two channels, wherein said treatment chamber at least partially surrounds a drum including a gas-permeable drum casing, wherein a strip-shaped material is at least partially arranged on said drum casing,
directing the gaseous treatment medium in the peripheral direction of said drum by means of said at least two channels,
discharging the gaseous treatment medium in an inside of said drum such that at least part of the gaseous treatment medium flows through the material arranged on said drum casing and said gas-permeable drum casing.

28. A method of treating a material, in particular drying a preferably strip-shaped material, comprising
feeding a gaseous treatment medium into a treatment chamber, wherein said treatment chamber at least partially surrounds a drum including a gas-permeable drum casing, wherein a strip-shaped material is at least partially arranged on said drum casing,
discharging the gaseous treatment medium in an inside of said drum such that at least part of the gaseous treatment medium flows through the material arranged on said drum casing and said gas-permeable drum casing, wherein
the gaseous treatment medium is fed in a manner distributed across the width of said drum to the treatment chamber at a peripheral region of said drum, wherein the width of said drum corresponds to the extension of said drum in an axially parallel direction, wherein the amount of the fed gaseous treatment medium is adapted to be varied.

29. The method according to claim 28, wherein a varying amount of gaseous treatment medium is fed in a manner distributed across the width of the drum.

30. The method according to claim 29, wherein in the edge areas of the drum an amount of gaseous treatment medium other than that in the center of the drum is fed, preferably, in the edge areas of said drum a larger amount of gaseous treatment medium is fed than in the center of said drum.

31. A method of treating a material, in particular drying a preferably strip-shaped material, comprising
arranging a strip-shaped material on a gas-permeable drum casing of a drum and transporting said strip-shaped material in the peripheral direction of said drum,
feeding at least a first gaseous treatment medium having a first temperature to a first portion of said material arranged on said drum casing,
feeding at least a second gaseous treatment medium having a second temperature to a second portion of said material arranged on said drum casing,
wherein the second portion is arranged downstream of the first portion as seen in the transport direction of the material,
discharging the gaseous treatment medium in an inside of said drum such that at least part of said first and second gaseous treatment media flows through said material arranged on said drum casing and said gas-permeable drum casing.

32. A device for treating a material, in particular for drying a preferably strip-shaped material, with a gaseous treatment medium which flows through the material, comprising
at least one drum including a gas-permeable drum casing, wherein said drum casing is covered at least in a peripheral region with said material adapted to be transported in the peripheral direction of said drum, and wherein in an inside of said drum a negative pressure is adapted to be applied,
a treatment chamber at least partially surrounding said drum, wherein upon application of the negative pressure in said inside of said drum at least part of the gaseous treatment medium flows from said treatment chamber through said material arranged on said drum casing and through said gas-permeable drum casing into the inside of said drum,
a shielding element arranged relative to said drum casing such that the flow of gas through said drum casing in the peripheral region of said drum which is not surrounded by the strip-shaped material is adapted to be reduced and preferably prevented, wherein said shielding element is arranged outside said drum.

33. A device for treating a material, in particular drying a preferably strip-shaped material, with a gaseous treatment medium which flows through the material, comprising
at least one drum including a gas-permeable drum casing, wherein said drum casing is at least partially covered with said material, and wherein in an inside of said drum a negative pressure is adapted to be applied,
a treatment chamber at least partially surrounding said drum, wherein upon application of the negative pressure in said inside of said drum the gaseous treatment medium flows from said treatment chamber through said material arranged on said drum casing and said drum casing into the inside of said drum, wherein
at least one drum guide element is arranged in said inside of said drum, wherein said at least one drum guide element is connected with said drum in the vicinity of at least one end wall of said drum, and wherein said at least one drum guide element is arranged such that the negative pressure applied to said drum casing is uniformized.

34. A device for treating a material, in particular drying a preferably strip-shaped material, with a gaseous treatment medium which flows through the material, comprising
at least one drum rotatable about a drum axis and including a gas-permeable drum casing, wherein said drum casing is at least partially covered with said material, and wherein in an inside of said drum a negative pressure is adapted to be applied, wherein said drum includes a first and a second drum hub,
a treatment chamber at least partially surrounding said drum, wherein upon application of the negative pressure in said inside of said drum the gaseous treatment medium flows from said treatment chamber through said material arranged on said drum casing and said drum casing into the inside of said drum, wherein
at least one drum hub is arranged in the axial direction of said drum and offset to the outside relative to said drum.
